(19) United States
(12) Patent Application Publication
(10) Pub. No.: US 2018/0108317 A1
(43) Pub. Date: Apr. 19, 2018

(54) LIQUID CRYSTAL DISPLAY APPARATUS AND DRIVING METHOD THEREOF

(71) Applicant: Wuhan China Star Optoelectronics Technology Co., L, Wuhan, Hubei (CN)

(72) Inventor: Feilin JI, Wuhan (CN)

(21) Appl. No.: 15/112,459

(22) PCT Filed: May 24, 2016
(86) PCT No.: PCT/CN2016/083073

§ 371 Date: Jul. 19, 2016

(30) Foreign Application Priority Data
May 4, 2016 (CN) 201610289271.2

(51) Int. Cl. G09G 3/36; G09G 3/20

(52) U.S. Cl. CPC G09G 3/3685; G09G 2300/0452; G09G 3/3618; G09G 3/2003

(57) ABSTRACT

A liquid crystal display apparatus and driving method, including a liquid crystal display panel, including M rows×N columns of sub-pixel units; a source driving module generating data signal voltages including

$$\frac{N}{2}$$

output channels; a data control module, including a plurality of first and second switches; connecting the

$$\frac{N}{2}$$

output channels to the corresponding

$$\frac{N}{2}$$

columns sub-pixel units, and the plurality of second switches connecting the

$$\frac{N}{2}$$

output channels to the rest of corresponding

$$\frac{N}{2}$$

columns sub-pixel units; and a switch driving module connecting to the first switch and the second switch, respectively; wherein during a time period when a row of sub-pixel units are turned on, the switch driving module controls the first switch and the second switch to perform a switching operation, to supply the data signal voltages output by the output channels timesharingly to the corresponding sub-pixel units; and wherein M and N are both positive integers

### TECHNICAL FIELD

The present invention relates to the liquid crystal display field, and more particularly, to a liquid crystal display apparatus and a driving method thereof.

### BACKGROUND ART

The liquid crystal display, or LCD, is a planar ultra-thin display apparatus which is composed of a certain amount of colorful or black-and-white pixels and disposed in front of a light source or a reflection plate. The crystal display enjoys its popularity and becomes a mainstream of the display due to its low power consumption, high-definition, small in size and light-weight etc. With the development of society, smart phones and PADs of small and medium sizes are becoming more and more popular in daily life, which also promotes the fast development of LCD technology, and the resolution of LCD has been increased from 480 P to 720 P, then to the current mainstream FHD (Full High Definition; Resolution 1080*1920). In addition, in small-size and medium-size applications, a refresh rate of LCD is always maintained at 60 Hz and is never increased. With the increasing demand of consumers, an LCD with a refresh rate of 120 Hz will also become the mainstream in future.

A liquid crystal display normally includes a liquid crystal display panel, a source driving module and a gate driving module. The liquid crystal display panel includes the sub-pixel units provided in an array form, the gate driving module turns on the sub-pixel units row by row, and when a row of sub-pixel units are turned on, the source driving module supplies a data signal voltage to the row of the sub-pixel units. The source driving module mainly converts the digital video data into the analog video data signal voltage to be supplied to the sub-pixel units, and numbers of output channels of the source driving module may correspond to numbers of each row of sub-pixel units one-by-one, so that when a row of sub-pixel units are turned on, the source driving module can supply the data signal voltage to the row of the sub-pixel units at the same time. However, the cost of the source driving module is relatively high, thus in industry, the numbers of the output channels of the source driving module and the sub-pixel units are configured by a ratio of 1:3, in order to reduce the number of the output channels of the source driving module, so as to lower the cost.

Specifically speaking, as shown in FIG. 1, for example, there are six sub-pixel units R₁, G₁, B₁, R₂, G₂, B₂ in each row (the actual liquid crystal panel should include a larger number of sub-pixel units), and the source driving module is configured with two output channels S₁ and S₂. Wherein the output channels S₁ and S₂ are connected to the sub-pixel units R₁ and R₂ through a group of first switches Q₁, to the sub-pixel units G₁ and G₂ through a group of second switches

Q₂, and to the sub-pixel units B₁ and B₂ through a group of third switches Q₃. According to the timing diagram as shown in FIG. 2, during a time when a row of sub-pixel units are turned on, through successive switching operations of the first switch Q₁, the second switch Q₂ and the third switch Q₃, the data signal voltages output by the output channels S₁ and S₂ are supplied timesharingly to the corresponding sub-pixel units R₁, G₁, B₁, R₂, G₂, B₂ for charging. In FIG. 2, Gate1 and Gate2 refer to the row scanning signal, and Q₁, Q₂, Q₃ refer to the control signals of the first switch Q₁, the second switch Q₂ and the third switch Q₃; wherein H represents a time when a row of sub-pixel units are turned on, T₁ represents a time interval between scanning each two successive rows, T₂ represents a time interval between each two successive switching operations of the first switch Q₁, the second switch Q₂ and the third switch Q₃, and T₃ represents a time period during which the first switch Q₁, the second switch Q₃ and the third switch Q₃ are turned on, respectively (i.e. a charging time period of each sub-pixel). Normally, T₁ is set as 0.9 μs, T₂ is at least 0.3 μs, and for security reasons, T₂ is normally set as 0.6 μs.

Regarding the FHD in small and medium size applications, a resolution is 1080*1920, and a display region thereof normally includes 1920 rows of pixels, normally, in vertical direction, some blank scanning periods such as VBP (Vsync Back Porch) and VFP (Vsync Front Porch) are often included, and VBP+VFP equals to about 60 rows. Thus a total number of scanned rows in vertical direction is 1980. According to the above charging architecture, when a refresh rate of LCD is 60 Hz, referring to FIG. 2, a time period during which each row of sub-pixel units are turned on is: H=1÷60÷1980=8.4 μs, let T₂ be 0.6 μs, then the charging time period of each sub-pixel is: T₃=1.7 pμs. Regarding the sub-pixels in the liquid crystal panel, normally the charging can be completed in a time period of more than 1 μs, thus T₃ is normally set as 1.5 μs.

However, according to the above charging architecture, when a refresh rate of the LCD is increased to 120 Hz, referring to FIG. 2, the time period during which each row of sub-pixel units are turned on is: H=1÷120÷1980=4.2 μs, let T₂ be the minimum time period 0.3 μs, and let T₁ be reduced to 0.6 μs, then the charging time period of each sub-pixel is: T₃=0.8 μs, thus the charging time period is smaller than 1 μs, which will cause a problem of undercharging.

### SUMMARY

To this end, the present disclosure provides a liquid crystal display apparatus and driving method thereof, to solve the problem of lacking in charging time period of the liquid crystal display panel with a resolution of 1080*1920 (FHD) or above and a refresh rate of 120 Hz.

In order to achieve the above purpose, the present disclosure adopts the following technical solutions:

a liquid crystal display apparatus, including: a liquid crystal display panel, including M rows×N columns of sub-pixel units; a source driving module, for generating a data signal voltage; wherein the source driving module includes

$$\frac{N}{2}$$

output channels; a data control module, including a plurality of first switches and a plurality of second switches; wherein the plurality of first switches connect the

$$\frac{N}{2}$$

output channels to the corresponding

$$\frac{N}{2}$$

columns sub-pixel units one by one, and the plurality of second switches connect the

$$\frac{N}{2}$$

output channels to the rest of corresponding

$$\frac{N}{2}$$

columns sub-pixel units one by one; and a switch driving module, connecting to the first switch and the second switch, respectively; wherein during a time period when a row of sub-pixel units are turned on, the switch driving module controls the first switch and the second switch to perform a switching operation, to supply the data signal voltages output by the output channels timesharingly to the corresponding sub-pixel units; and wherein M and N are both positive integer.

Wherein the

$$\frac{N}{2}$$

output channels include sequentially: S₆ₓ₊₁, S₆ₓ₊₂, S₆ₓ₊₃, S₆ₓ₊₄, S₆ₓ₊₅, S₆ₓ₊₆;

the sub-pixel units include a red sub-pixel R, a green sub-pixel a blue sub-pixel B; each row of sub-pixel units include sequentially: R₄ₓ₊₁, G₄ₓ₊₁, B₄ₓ₊₁, R₄ₓ₊₂, G₄ₓ₊₂, B₄ₓ₊₂, R₄₊₃, G₄ₓ₊₃, B₄ₓ₊₃, R₄ₓ₊₄, G₄ₓ₊₄, B₄ₓ₊₄; wherein the output channel S₆ₓ₊₁ is connected to the sub-pixel R₄ₓ₊₁ through the first switch, and is connected to the sub-pixel B₄ₓ₊₁ through the second switch; the output channel S₆ₓ₊₂ is connected to the sub-pixel G₄ₓ₊₁ through the first switch, and is connected to the sub-pixel R₄ₓ₊₂ through the second switch; the output channel S₆ₓ₊₃ is connected to the sub-pixel G₄ₓ₊₂ through the first switch, and is connected to the sub-pixel R₄ₓ₊₃ through the second switch; the output channel S₆ₓ₊₄ is connected to the sub-pixel B₄ₓ₊₂ through the first switch, and is connected to the sub-pixel G₄ₓ₊₃ through the second switch; the output channel S₆ₓ₊₅ is connected to the sub-pixel B₄ₓ₊₃ through the first switch, and is connected to the sub-pixel G₄ₓ₊₄ through the second switch; and the output channel S₆ₓ₊₆ is connected to the sub-pixel R₄ₓ₊₄ through the first switch, and is connected to the sub-pixel B₄ₓ₊₄ through the second switch; wherein polarities of the data signal voltages output by two adjacent output channels are opposite to each other, and each time when a frame of picture data is transmitted, the polarities of the data signal voltages output by the output channels are inverted for once; and wherein x=0, 1, 2, . . . ,

$$\frac{N}{12} .$$

Wherein a resolution of the liquid crystal display panel is 1080×1920 or above; a refresh rate of the liquid crystal display panel is 120 Hz.

Wherein the switch control module controls the first switch and the second switch to perform a switching operation according to an equal duration relationship.

Wherein the liquid crystal display apparatus further includes a gate driving module for supplying a scanning signal voltage to the sub-pixel units.

A driving method of the liquid crystal display apparatus as mentioned above, including:

generating a data signal voltage by the source driving module and outputting the generated voltage through the

$$\frac{N}{2}$$

output channels; and

during a time period when a row of sub-pixel units are turned on, controlling the first switch and the second switch to perform a switching operation by the switch driving module, to supply the data signal voltages output by the

$$\frac{N}{2}$$

output channels timesharingly to the corresponding sub-pixel units.

Compared with the prior art, in the liquid crystal display apparatus and driving method thereof provided by the embodiment of the present disclosure, the numbers of the output channels of the source driving module and each row of the sub-pixel units are configured by a ratio of 1:2, thus reducing the number of the output channels of the source driving module to a maximum extent, while solving the problem of lacking in charging time period of the LCD with a resolution of 1080*1920 (FHD) or above and a refresh rate of 120 Hz.

### BRIEF DESCRIPTION OF THE DRAWINGS

FIG. 1 is an exemplary diagram of a source driving module transmitting data signal to sub-pixel units in the prior art;

FIG. 2 is a timing diagram of transmitting data signal as shown in FIG. 1;

FIG. 3 is a structure diagram of a liquid crystal display apparatus provided by an embodiment of the present disclosure;

FIG. 4 is an exemplary diagram of a source driving module transmitting data signal to sub-pixel units in the embodiment of the present disclosure;

FIG. 5 is a timing diagram of transmitting data signal as shown in FIG. 4.

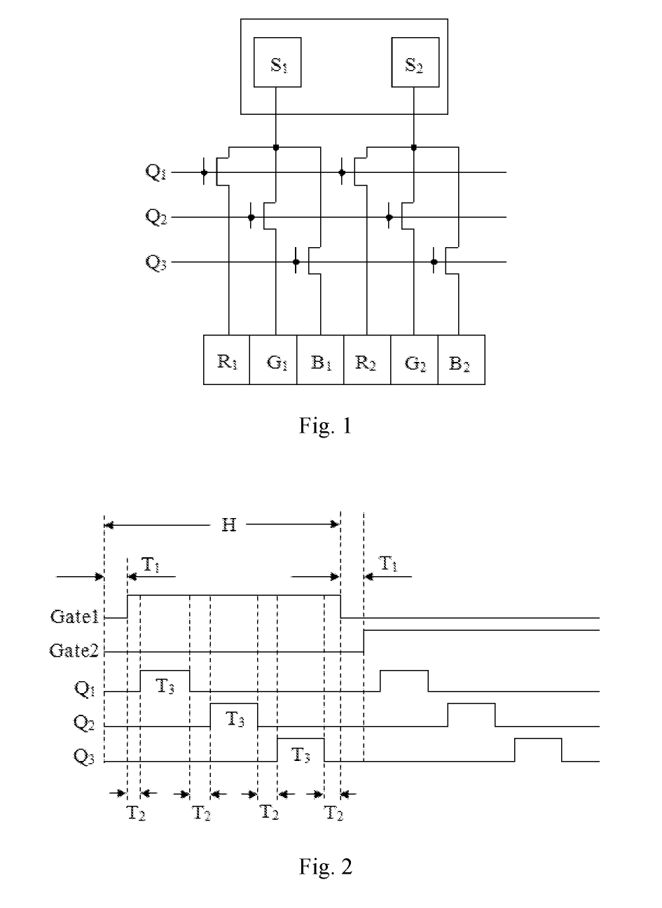

### DETAILED DESCRIPTION OF EXEMPLARY EMBODIMENTS

In order for the purpose, technical solution and advantages of the present disclosure to be clearer and understood, the embodiments of the present disclosure will be further explained below in conjunction with the drawings. The preferred embodiments are exemplified in the drawings. The embodiments of the present disclosure as shown in the drawings and as described according to the drawings are only exemplified, and the present disclosure is not limited to these embodiments.

Here, the examiner needs to explain the following points: in order to prevent the present disclosure from being obscured due to unnecessary details, the drawings only illustrate the structure and/or processing steps closely related to the solution based on the present disclosure, while other details less related to the present disclosure are omitted.

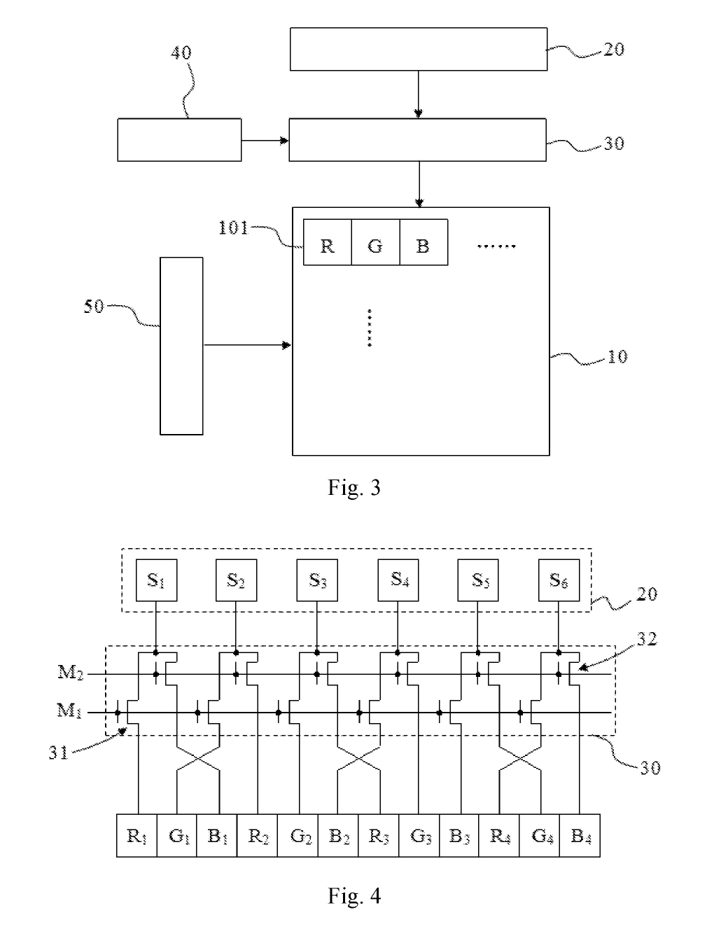

The present embodiment first provides a liquid crystal display apparatus, as shown in FIG. 3, the liquid crystal display apparatus includes a liquid crystal display panel 10, a source driving module 20, a data control module 30, a switch driving module 40 and a gate driving module 50.

Wherein the liquid crystal display panel 10 is provided with M rows×N columns of sub-pixel units 101, and the sub-pixel units 101 include a red sub-pixel R, a green sub-pixel and a blue sub-pixel B. FIG. 1 only exemplifies three of the sub-pixel units 101, and in each row of sub-pixel units 101, the red sub-pixel R, the green sub-pixel G and the blue sub-pixel B are arranged successively and are repeatedly arranged in such a periodic manner; wherein M and N are both positive integers, normally, the values of M and N are relatively large.

Wherein the source driving module 20 mainly converts the digital video data into the analog video data signal voltage to be supplied to the sub-pixel units 101. The gate driving module 50 mainly supplies a scanning signal to each row of sub-pixel units 101, in order to turn on the sub-pixel units 101 row by row, after the gate driving module 50 provides the scanning signal to a row of sub-pixel units 101, the source driving module 20 supplies a data signal voltage to the sub-pixel units 101.

Wherein the data control module 30 controls a process of the source driving module 20 charging the sub-pixel units 101 (providing the data signal voltage), while the switch driving module 40 is used for driving a working state of the data control module 30.

Wherein referring to FIGS. 3 and 4, in the present embodiment, the numbers of the output channels of the source driving module 20 and each row of the sub-pixel units 101 are configured by a ratio of 1:2. That is, for M rows×N columns of sub-pixel units 101, if a number of each row of sub-pixel units 101 is N, the source driving module 20 is provided with

$$\frac{N}{2}$$

output channels. The data control module 30 mainly includes a plurality of first switches 31 and a plurality of second switches 32; and the plurality of first switches 31 connect the

$$\frac{N}{2}$$

output channels to the corresponding

$$\frac{N}{2}$$

columns sub-pixel units 101 one by one, and the plurality of second switches 32 connect the

$$\frac{N}{2}$$

output channels to the rest of corresponding

$$\frac{N}{2}$$

columns sub-pixel units 101 one by one. The switch driving module 40 is connected to the first switch 31 and the second switch 32, respectively. Wherein during a time period when a row of sub-pixel units 101 are turned on, the switch driving module 40 controls the first switch 31 and the second switch 32 to perform a switching operation, to supply the data signal voltages output by the output channels timesharingly to the corresponding sub-pixel units 101.

Specifically speaking, in the present embodiment, the

$$\frac{N}{2}$$

output channels are indicated sequentially as: S₆ₓ₊₁, S₆ₓ₊₂, S₆ₓ₊₃, S₆ₓ₊₄, S₆ₓ₊₅, S₆ₓ₊₆, wherein x=0, 1, 2, . . . ,

$$\frac{N}{12} ;$$

and each row of sub-pixel units 101 are indicated sequentially as: R₄ₓ₊₁, G₄ₓ₊₁, B₄ₓ₊₁, R₄ₓ₊₂, G₄ₓ₊₂, B₄ₓ₊₂, R₄ₓ₊₃, G₄ₓ₊₃, B₄ₓ₊₃, R₄ₓ₊₄, G₄ₓ₊₄, B₄ₓ₊₄, wherein x=0, 1, 2, . . . ,

$$\frac{N}{12} .$$

Wherein the output channel S₆ₓ₊₁ is connected to the sub-pixel R₄ₓ₊₁ through the first switch 31, and is connected to the sub-pixel B₄ₓ₊₁ through the second switch 32; the output channel S₆ₓ₊₂ is connected to the sub-pixel G₄ₓ₊₁ through the first switch 31, and is connected to the sub-pixel R₄ₓ₊₂ through the second switch 32; the output channel S₆ₓ₊₃ is connected to the sub-pixel G₄ₓ₊₂ through the first switch 31, and is connected to the sub-pixel R₄ₓ₊₃ through the second switch 32; the output channel S₆ₓ₊₄ is connected to the sub-pixel B₄ₓ₊₂ through the first switch 31, and is connected to the sub-pixel R₄ₓ₊₃ through the second switch 32; the output channel S₆ₓ₊₅ is connected to the sub-pixel B₄ₓ₊₃ through the first switch 31, and is connected to the sub-pixel R₄ₓ₊₄ through the second switch 32; and the output channel S₆ₓ₊₆ is connected to the sub-pixel R₄ₓ₊₄ through the first switch 31, and is connected to the sub-pixel B₄ₓ₊₄ through the second switch 32.

The structure as shown in FIG. 4 is illustrated by taking x=0 for example. As shown in FIG. 4, the source driving module 20 includes output channels S₁, S₂, S₃, S₄, S₅, S₆, and the corresponding sub-pixel units are: R₁, G₁, B₁, R₂, G₂, B₂, R₃, G₃, B₃, R₄, G₄, B₄, and the data control module 30 includes six first switches 31 and six second switches 32. Wherein the output channel S₁ is connected to the sub-pixel R₁ through one first switch 31, and is connected to the sub-pixel B₁ through one second switch 32; the output channel S₂ is connected to the sub-pixel G₁ through one first switch 31, and is connected to the sub-pixel R₂ through one second switch 32; the output channel S₃ is connected to the sub-pixel G₂ through one first switch 31, and is connected to the sub-pixel R₃ through one second switch 32; the output channel S₄ is connected to the sub-pixel B₂ through one first switch 31, and is connected to the sub-pixel G₃ through one second switch 32; the output channel S₅ is connected to the sub-pixel B₃ through one first switch 31, and is connected to the sub-pixel G₄ through one second switch 32; and the output channel S₆ is connected to the sub-pixel R₄ through one first switch 31, and is connected to the sub-pixel B₄ through one second switch 32. Wherein a control signal M₁ of the first switch 31 and a control signal M₂ of the second switch are provided by the switch driving module 40. It is easily conceivable that: in a row direction of the liquid crystal panel, the structure as shown in FIG. 4 is

repeated periodically, that is, the structures corresponding to x=1, x=2, x=3, . . . ,

$$x = \frac{N}{12}$$

are repeated.

The specific driving method of the liquid crystal display apparatus as mentioned above includes:

supplying a scanning signal to each row of sub-pixel units 101 row by row by the gate driving module 50, in order to turn on the corresponding sub-pixel units 101;

generating a data signal voltage by the source driving module 20 and outputting the generated voltage through the

$$\frac{N}{2}$$

output channels;

during a time period when a row of sub-pixel units 101 are turned on, controlling the first switch 31 and the second switch 32 in the data control module 30 to perform a switching operation by the switch driving module 40, to supply the data signal voltages output by the

$$\frac{N}{2}$$

output channels timesharingly to the corresponding sub-pixel units 101.

Still taking the structure as shown in FIG. 4 for example, after the gate driving module 50 supplies the scanning signal to the sub-pixel units R₁, G₁, B₁, R₂, G₂, B₂, R₃, G₃, B₃, R₄, G₄, B₄, controlling the first switch 31 in the data control module 30 to switch on by the switch driving module 40 (in which case the second switch 32 is switched off), inputting the data signal voltage to the sub-pixel units R₁, G₁, G₂, B₂, B₃, R₄ through the output channels S₁˜S₆ of the source driving module 20, respectively, then switching on the second switch 32 in the data control module 30 by the switch driving module 40 (in which case the first switch 31 is switched off), and inputting the data signal voltage to the rest sub-pixel units B₁, R₂, R₃, G₃, G₄, B₄ through the output channels S₁˜S₆ of the source driving module 20, respectively, to eventually complete charging of a whole row of sub-pixels.

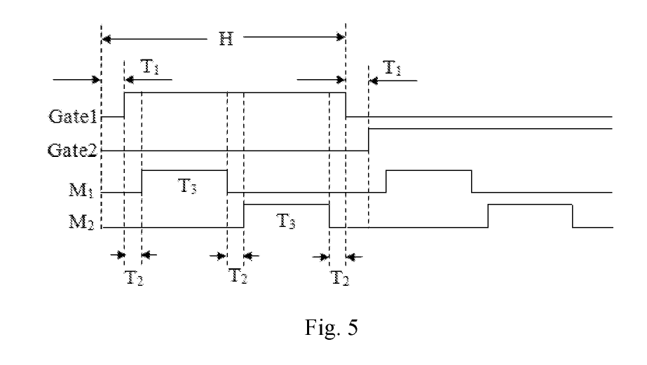

Referring to timing diagram as shown in FIG. 4 and FIG. 5, during a time when a row of sub-pixel units are turned on, through successive switching operations of the first switch 31 and the second switch 32, the data signal voltages output by the output channels are supplied timesharingly to the corresponding sub-pixel units for charging. In FIG. 5, Gate1 and Gate2 refer to the row scanning signal, M₁ and M₂ refer to the control signals of the first switch 31 and the second switch 32, respectively; and wherein H represents time when a row of sub-pixel units are turned on, T₁ represents a time interval between scanning each two successive rows, T₂ represents a time interval between each two successive switching operations of the first switch 31 and the second switch 32, and T₃ represents a time period during which the first switch 31 and the second switch 32 are turned on, respectively (i.e. a charging time period of each sub-pixel). Normally, T₁ is set as 0.6˜0.9 μs, T₂ should be at least 0.3 μs. Wherein the switch control module 40 controls the first switch 31 and the second switch 32 to perform a switching operation according to an equal duration relationship, that is, the time periods during which the first switch 31 and the second switch 32 are switched on are identical to each other.

Furthermore, the liquid crystal display apparatus and the driving method thereof as mentioned above are mainly used to secure enough time for charging the liquid crystal display panel with a resolution of above 1080*1920 and a refresh rate of 120 Hz.

Taking a resolution of 1080*1920 and a refresh rate of 120 Hz for example, referring to FIG. 5, the time period during which each row of sub-pixel units are turned on is: H=1÷120÷1980=4.2 μs, T₁ is set as 0.6 μs, T₂ is set as 0.3 μs, then the charging time period of each sub-pixel is: T₃=1.35 μs, and the charging time period is larger than 1 μs, which satisfies the time demands for charging.

Furthermore, in the present embodiment, the polarities of the data signal voltages output by two adjacent output channels in the source driving module 20 are opposite to each other, also, each time when a frame of picture data is transmitted, the polarities of the data signal voltages output by the output channels are inverted for once. Specifically speaking, still taking the structure as shown in FIG. 4 for example, if the polarities of the data signal voltages output by the output channels S₁, S₃ and S₅ are positive in a picture of i^{th} frame, the polarities of the data signal voltages output by the output channels S₂, S₄ and S₆ are negative, accordingly, the pixel units R₁ , B₁, G₂, R₃, B₃, G₄ are charged with the positive polarities, and the pixel units G₁, R₂ , B₂ , G₃, R₄, B₄ are charged with the negative polarities; also, in a picture of i+1^{th} frame, the polarities of the data signal voltages output by the output channels S₁, S₃ and S₅ should be inverted to negative polarities, the polarities of the data signal voltages output by the output channels S₂, S₄ and S₆ should be inverted to positive polarities, accordingly, the pixel units R₁, B₁, G₂, R₃, B₃, G₄ are charged with the negative polarities, and the pixel units G₁, R₂, B, G₃, R₄, B₄ are charged with the positive polarities. Accordingly, when displaying a picture of a frame, the polarities of the charging voltages of two adjacent sub-pixel units in the same row of pixel units are opposite to each other, when displaying pictures of two adjacent frames, the polarities of the charging voltages of the same sub-pixel unit are opposite to each other. Based on above, the display quality of the liquid crystal display panel may be improved, and the life of the liquid crystal may be increased.

It should be noted that: the above-mentioned polarities of the data signal voltages output by the output channels being positive or negative is given based on the comparison result between the data signal voltage output by the output channel and the common voltage of the liquid crystal display panel, if the data signal voltage output by the output channel is larger than the common voltage, the polarity is positive, and if the data signal voltage output by the output channel is smaller than the common voltage, the polarity is negative.

As mentioned above, in the liquid crystal display apparatus and driving method thereof provided by the embodiment of the present disclosure, the numbers of the output channels of the source driving module and each row of the sub-pixel units are configured by a ratio of 1:2, thus reducing the number of the output channels of the source driving module to a maximum extent, while solving the problem of lacking in charging time period of the LCD with a resolution of 1080*1920 (FHD) and/or above at a refresh rate of 120 Hz.

It should be noted that: the relationship terms, such as first and second, etc., in the present text are only used for distinguishing one entity or operation from another entity or operation without requiring or implying any actual relation or sequence existing between these entities or operations. Also, the term “include”, “contain” or any other variant means covering instead of exclusively including, so that the process, method, object or device including a series of factors not only includes those factors but also includes other factors that are not explicitly listed or further include inherent factors for this process, method, object or device. Where no more limitations are provided, the factors defined by the sentence “include one . . . ” do not exclude additional identical factors existing in the process, method, object or device which includes the factors.

The above statements are only the specific embodiments of the present application, it should be pointed out that, to those ordinary skilled in the art, several improvements and polish can be made without breaking away from the principle of the present application, also those improvements and polish should be considered as the protection scope of the present application.

What is claimed:

1. A liquid crystal display apparatus, including:
a liquid crystal display panel, including M rows×N columns of sub-pixel units;
a source driving module, for generating a data signal voltage; wherein the source driving module includes
$$\frac{N}{2}$$
output channels;
a data control module, including a plurality of first switches and a plurality of second switches; wherein the plurality of first switches connect the
$$\frac{N}{2}$$
output channels to the corresponding
$$\frac{N}{2}$$
columns sub-pixel units one by one, and the plurality of second switches connect the
$$\frac{N}{2}$$
output channels to the rest of corresponding
$$\frac{N}{2}$$
columns sub-pixel units one by one; and
a switch driving module, connecting to the first switch and the second switch, respectively;
wherein during a time period when a row of sub-pixel units are turned on, the switch driving module controls the first switch and the second switch to perform a switching operation, to supply the data signal voltages output by the output channels timesharingly to the corresponding sub-pixel units; and
wherein M and N are both positive integers.

2. The liquid crystal display apparatus of claim 1, wherein the
$$\frac{N}{2}$$
output channels sequentially: S₆ₓ₊₁, S₆ₓ₊₂, S₆ₓ₊₃, S₆ₓ₊₄, S₆ₓ₊₅, S₆ₓ₊₆;
the sub-pixel units include a red sub-pixel R, a green sub-pixel a blue sub-pixel B; each row of sub-pixel units include sequentially: R₄ₓ₊₁, G₄ₓ₊₁, B₄ₓ₊₁, R₄ₓ₊₂, G₄ₓ₊₂, B₄ₓ₊₂, R₄ₓ₊₃, G₄ₓ₊₃, B₄ₓ₊₃, R₄ₓ₊₄, G₄ₓ₊₄, B₄ₓ₊₄;
wherein the output channel S₆ₓ₊₁ is connected to the sub-pixel R₄ₓ₊₁ through the first switch, and is connected to the sub-pixel B₄ₓ₊₁ through the second switch; the output channel S₆ₓ₊₂ is connected to the sub-pixel G₄ₓ₊₁ through the first switch, and is connected to the sub-pixel R₄ₓ₊₂ through the second switch; the output channel S₆ₓ₊₃ is connected to the sub-pixel G₄ₓ₊₂ through the first switch, and is connected to the sub-pixel R₄ₓ₊₃ through the second switch; the output channel S₆ₓ₊₄ is connected to the sub-pixel B₄ₓ₊₂ through the first switch, and is connected to the sub-pixel G₄ₓ₊₃ through the second switch; the output channel S₆ₓ₊₅ is connected to the sub-pixel B₄ₓ₊₃ through the first switch, and is connected to the sub-pixel G₄ₓ₊₄ through the second switch; and the output channel S₆ₓ₊₆ is connected to the sub-pixel R₄ₓ₊₄ through the first switch, and is connected to the sub-pixel B₄ₓ₊₄ through the second switch;
wherein polarities of the data signal voltages output by two adjacent output channels are opposite to each other, and each time when a frame of picture data is transmitted, the polarities of the data signal voltages output by the output channels are inverted for once; and
wherein x=0, 1, 2, . . . ,
$$\frac{N}{12} .$$

3. The liquid crystal display apparatus of claim 1, wherein a resolution of the liquid crystal display panel is 1080×1920 or above.

4. The liquid crystal display apparatus of claim 3, wherein a refresh rate of the liquid crystal display panel is 120 Hz.

5. The liquid crystal display apparatus of claim 4, wherein the switch control module controls the first switch and the second switch to perform a switching operation according to an equal duration relationship.

6. The liquid crystal display apparatus of claim 2, wherein a resolution of the liquid crystal display panel is 1080×1920 or above; a refresh rate of the liquid crystal display panel is 120 Hz.

7. The liquid crystal display apparatus of claim 6, wherein a refresh rate of the liquid crystal display panel is 120 Hz.

8. The liquid crystal display apparatus of claim 7, wherein the switch control module controls the first switch and the second switch to perform a switching operation according to an equal duration relationship.

9. The liquid crystal display apparatus of claim 1, wherein the liquid crystal display apparatus further includes a gate driving module for supplying a scanning signal voltage to the sub-pixel units.

10. A driving method of a liquid crystal display apparatus, the display device comprising: a liquid crystal display panel, including M rows x N columns of sub-pixel units; a source driving module, for generating a data signal voltage; wherein the source driving module includes
$$\frac{N}{2}$$
output channels; a data control module, including a plurality of first switches and a plurality of second switches; wherein the plurality of first switches connect the
$$\frac{N}{2}$$
output channels to the corresponding
$$\frac{N}{2}$$
columns sub-pixel units one by one, and the plurality of second switches connect the
$$\frac{N}{2}$$
output channels to the rest of corresponding
$$\frac{N}{2}$$
columns sub-pixel units one by one; and a switch driving module, connecting to the first switch and the second switch, respectively;
the driving method including:
generating a data signal voltage by the source driving module and outputting the generated voltage through the
$$\frac{N}{2}$$
output channels; and
during a time period when a row of sub-pixel units are turned on, controlling the first switch and the second switch to perform a switching operation by the switch driving module, to supply the data signal voltages output by the
$$\frac{N}{2}$$
output channels timesharingly to the corresponding sub-pixel units;
wherein M and N are both positive integers.

11. The driving method of claim 6, wherein the
$$\frac{N}{2}$$
output channels include sequentially: S₆ₓ₊₁, S₆ₓ₊₂, S₆ₓ₊₃, S₆ₓ₊₄, S₆ₓ₊₅, S₆ₓ₊₆;
the sub-pixel unit include a red sub-pixel R, a green sub-pixel a blue sub-pixel B; each row of sub-pixel units include sequentially: R₄ₓ₊₁, G₄ₓ₊₁, B₄ₓ₊₁, R₄ₓ₊₂, G₄ₓ₊₂, B₄ₓ₊₂, R₄ₓ₊₃, G₄ₓ₊₃, B₄ₓ₊₃, R₄ₓ₊₄, G₄ₓ₊₄, B₄ₓ₊₄;
wherein the output channel S₆ₓ₊₁ supplies the output data signal voltages timesharingly to the sub-pixel R₄ₓ₊₁ and the sub-pixel B₄ₓ₊₁; the output channel S₆ₓ₊₂ supplies the output data signal voltages timesharingly to the sub-pixel G₄ₓ₊₁ and the sub-pixel R₄ₓ₊₂; the output channel S₆ₓ₊₃ supplies the output data signal voltages timesharingly to the sub-pixel G₄ₓ₊₂ and the sub-pixel R₄ₓ₊₃; the output channel S₆ₓ₊₄ supplies the output data signal voltages timesharingly to the sub-pixel B₄ₓ₊₂ and the sub-pixel G₄ₓ₊₃; the output channel S₆ₓ₊₅ supplies the output data signal voltages timesharingly to the sub-pixel B₄ₓ₊₃ and the sub-pixel G₄ₓ₊₄; the output channel S₆ₓ₊₆ supplies the output data signal voltages timesharingly to the sub-pixel R₄ₓ₊₄ and the sub-pixel B₄ₓ₊₄;
wherein polarities of the data signal voltages output by two adjacent output channels are opposite to each other, and each time when a frame of picture data is transmitted, the polarities of the data signal voltages output by the output channels are inverted for once; and
wherein x=0, 1, 2, . . . ,
$$\frac{N}{12} .$$

12. The driving method of claim 10, wherein a resolution of the liquid crystal display panel is 1080×1920 or above.

13. The driving method of claim 12, wherein a refresh rate of the liquid crystal display panel is 120 Hz.

14. The driving method of claim 13, wherein the switch control module controls the first switch and the second switch to perform a switching operation according to an equal duration relationship.

15. The driving method of claim 11, wherein a resolution of the liquid crystal display panel is 1080×1920 or above.

16. The driving method of claim 15, wherein a refresh rate of the liquid crystal display panel is 120 Hz.

17. The driving method of claim 16, wherein the switch control module controls the first switch and the second switch to perform a switching operation according to an equal duration relationship.

18. The driving method of claim 10, wherein the liquid crystal display apparatus further includes a gate driving module for supplying the scanning signal to the sub-pixel units.
